(19) United States
(12) Patent Application Publication
(10) Pub. No.: US 2008/0260025 A1
(43) Pub. Date: Oct. 23, 2008

(54) CODING RATE CONVERTING APPARATUS, INTEGRATED CIRCUIT, AND METHOD, AND PROGRAM FOR THE SAME

(76) Inventor: Yoshiyuki Wada, Osaka (JP)

Correspondence Address: WENDEROTH, LIND & PONACK L.L.P., 2033 K. STREET, NW, SUITE 800, WASHINGTON, DC, 20006, US

(21) Appl. No.: 12/103,549

(22) Filed: Apr. 15, 2008

(30) Foreign Application Priority Data
Apr. 20, 2007 (JP) 2007-111276

(51) Int. Cl. H04N 11/04

(52) U.S. Cl. 375/240.03

(57) ABSTRACT

A coding rate converting apparatus according to the present invention re-quantizes first quantized data with a first quantization step size, using a second quantization step size larger than the first quantization step size, and includes: an inverse quantization unit generating orthogonal transform coefficients by inversely quantizing the first quantized data for each of unit blocks; a quantization unit generating second quantized data by quantizing the orthogonal transform coefficients using the second quantization step size; a filter intensity change judging unit judging whether a second filter intensity determined based on the second quantized data is changed from a first filter intensity determined based on the first quantized data; and a coefficient correcting unit generating, in the case of the second filter intensity, third quantized data by correcting the second quantized data so that a third filter intensity determined based on the third quantized data becomes equal to the first filter intensity.

### BACKGROUND OF THE INVENTION

(1) Field of the Invention

The present invention relates to a coding rate converting apparatus, integrated circuit, and method, and a program for the same, and in particular to a coding rate converting apparatus which re-quantizes first quantized data, which has been quantized using a first quantization step size, using a second quantization step size larger than the first quantization step size.

(2) Description of the Related Art

Recent years have seen the use of H. 264/Advanced Video Coding (AVC) which achieves a compression rate higher than the one achieved by Moving Picture Experts Group 2 (MPEG-2), as an image coding technique used for digital broadcasting and DVDs. The H. 264 AVC achieves a coding efficiency better than the one achieved by any other conventional coding standards by using new techniques such as deblocking filtering and arithmetic coding.

The deblocking filtering newly employed in the H. 264/AVC standard is a technique for reducing block distortion which occurs in the coding of pictures, and disclosed in Non-patent Reference: ITU-T Recommendation H. 264: Advanced video coding for audiovisual services.

FIG. 1 is a block diagram showing the structure of a decoding apparatus according to the H. 264/AVC standard.

A decoding apparatus 900 in FIG. 1 generates decoded pixels by decoding an H. 264/AVC stream.

Decoding in H. 264/AVC is performed on a macroblock-by-macroblock basis (a macroblock is also referred to as an MB, hereinafter).

The decoding apparatus 900 includes a variable length decoding unit 901, an inverse quantization unit 902, an inverse orthogonal transform unit 903, an intra-predictive reference picture storage unit 904, an intra-predictive decoding unit 905, a motion compensation predictive decoding unit 906, a motion compensation predictive reference picture storage unit 907, and a deblocking filtering unit 908.

The variable length decoding unit 901 generates quantized orthogonal transform coefficients by decoding an H. 264/AVC stream. The inverse quantization unit 902 reconstructs the quantized orthogonal transform coefficients generated by the variable length decoding unit 901 into orthogonal transform coefficients. The inverse orthogonal transform unit 903 reconstructs pixel residuals by performing inverse orthogonal transform on the orthogonal transform coefficients reconstructed by the inverse quantization unit 902.

In the case of an intra MB (an MB on which intra-prediction is to be performed), the inverse orthogonal transform unit 903 outputs pixel residuals to the intra-predictive decoding unit 905. The intra-predictive decoding unit 905 generates reconstructed pixels by performing intra-predictive decoding by using pixel information decoded in the past and stored in the intra-predictive reference picture storage unit 904 and pixel residuals inputted from the inverse orthogonal transform unit 903. The intra-predictive decoding unit 905 outputs the generated reconstructed pixels to the deblocking filtering unit 908 and stores the pixels in the intra-predictive reference picture storage unit 904. The reconstructed pixels stored in the intra-predictive reference picture storage unit 904 are referred to in the intra-predictive decoding of succeeding MBs in the same picture.

In the case of an inter MB (an MB on which inter-prediction is to be performed), the inverse orthogonal transform unit 903 outputs pixel residuals to the motion compensation predictive reference decoding unit 906. The motion compensation predictive decoding unit 906 generates reconstructed pixels by performing motion compensation predictive decoding by using pixel information decoded in the past and stored in the motion compensation predictive reference picture storage unit 907 and pixel residuals inputted from the inverse orthogonal transform unit 903. The motion compensation predictive reference decoding unit 906 outputs the generated reconstructed pixels to the deblocking filtering unit 908.

The deblocking filtering unit 908 generates pixels to be reproduced by performing deblocking filtering on the reconstructed pixels inputted from the intra-predictive decoding unit 905 or the motion compensation predictive decoding unit 906. The deblocking filtering unit 908 outputs the generated pixels to be reproduced as decoding results and stores the pixels in the motion compensation predictive reference picture storage unit 907. The pixels to be reproduced stored in the motion compensation predictive reference picture storage unit 907 are referred to in the motion compensation predictive decoding of the succeeding pictures.

The deblocking filtering is illustrated below.

FIG. 2 is a diagram showing an example of block boundaries on which deblocking filtering is performed.

The deblocking filtering is intended for reducing noises at block boundaries (edges) in the horizontal direction and the vertical direction of unit blocks 910 on which orthogonal transform is performed.

The unit blocks 910 include 4×4 or 8×8 pixels 911. Note that a unit block is simply referred to as a block, hereinafter.

In the case where deblocking filtering is performed at block boundaries in the horizontal direction or the vertical direction, filtering is performed using 8 pixels adjacent to the block boundaries. This filtering updates the pixel values of 6 pixels (p2, p1, p0, q0, q1, and q2) which form the block boundaries. For more details of deblocking filtering, refer to the above-identified Non-patent Reference.

Hereinafter, the unit block which is being currently focused on among the blocks on which deblocking filtering is about to be performed is referred to as a current block, and a unit block which is adjacent to the current block and forms the block boundary is referred to as an adjacent block.

In the deblocking filtering, the strength of a filter (filter intensity) is controlled according to a parameter called boundary filter strength (bS). A bS is determined, for each block boundary on which deblocking filtering is performed, based on current block information and adjacent block information, and the value of a bS is set as one of 0, 1, 2, 3, and 4. As the value of a bS increases, a stronger filter is applied to a block boundary so as to smooth the block boundary. In the case where a bS is 0, no filter is applied to a corresponding block boundary.

FIG. 3 is a diagram showing a bS determination method. Here, p0 and q0 in FIG. 3 correspond to p0 and q0 in FIG. 2, respectively. As shown in FIG. 3, a bS is determined based on current block information and adjacent block information indicating, for example, whether a current block boundary is an MB boundary, and whether the MB including p0 and q0 is an intra MB.

Meanwhile, the picture coding techniques such as MPEG-2 and H. 264/AVC are used as video data format for digital broadcast and recording media such as DVDs. MPEG-2 and H. 264/AVC make it possible to select bit rates within a certain range depending on applications.

There is a method for recording high-definition digital broadcast in a recording media after reducing the bit rate of the broadcast by converting the coding rate instead of recording the original high-quality data directly. By reducing the information amount in this way, it becomes possible to record larger data in a recording media. In addition, needs to perform high-speed dabbing while converting coding rates are also increasing. By performing high-speed dabbing, it becomes possible to utilize a recording medium to its full capacity.

An example of such coding rate converting method is an open-loop converting method. The open-loop converting method is a technique for decoding an input stream to the level of inversely quantized orthogonal transform coefficients instead of decoding the input stream to the pixel level, and quantizing the coefficients using different quantization step sizes. This makes it possible to convert the input stream to a desirable data amount requiring small processing amount, compared with the case of decoding the input stream to the pixel level.

A conventional open-loop coding rate converting apparatus is illustrated below.

FIG. 4 is a block diagram showing the structure of the conventional open-loop coding rate converting apparatus. The coding rate converting apparatus 200 shown in FIG. 4 generates a stream with reduced information amount by changing the coding rate of a variable length coded input stream.

The coded rate converting apparatus 200 includes a variable length decoding unit 201, a variable length coding unit 202, a rate control unit 203, a Q-value transform unit 204, a header storage unit 205, an inverse quantization unit 206, and a quantization unit 207.

The variable length decoding unit 201 generates quantized orthogonal transform coefficients and MB headers which are MB data other than quantized orthogonal transform coefficients by decoding the variable length coded input stream. The variable length decoding unit 201 simultaneously outputs the parameters included in the MB headers to the header storage unit 205 and outputs the quantization step sizes included in the MB headers to the Q-value transform unit 204. In addition, the variable length decoding unit 201 outputs the generated quantized orthogonal transform coefficients to the inverse quantization unit 206.

The rate control unit 203 calculates target quantization step sizes according to target bit rates, and outputs the calculated target quantization step sizes to the Q-value transform unit 204.

The Q-value transform unit 204 determines new quantization step sizes obtained through rate conversion using the quantization step sizes outputted by the variable length decoding unit 201 and the target quantization step sizes outputted by the rate control unit. The Q-value transform unit 204 outputs the newly determined quantization step sizes to the quantization unit 207 and the header storage unit 205.

The header storage unit 205 rewrites the quantization step sizes included in the MB headers into the new quantization step size values determined by the Q-value transform unit 204. The header storage unit 205 outputs the updated MB headers to the variable length coding unit 202.

The inverse quantization unit 206 generates orthogonal transform coefficients by inversely quantizing the quantized orthogonal transform coefficients outputted by the variable length decoding unit 201, and outputs the generated orthogonal transform coefficients to the quantization unit 207.

The quantization unit 207 generates quantized orthogonal transform coefficients by quantizing orthogonal transform coefficients outputted by the inverse quantization unit 206 according to the new quantization step sizes determined by the Q-value transform unit 204. The quantization unit 207 outputs the generated quantized orthogonal transform coefficients to the variable length coding unit 202.

The variable length coding unit 202 generates a stream with an updated coding rate by performing variable length coding on the MB headers outputted by the header storage unit 205 and the quantized orthogonal transform coefficients outputted by the quantization unit 207.

The rate control unit 203 corrects, as necessary, target bit rates based on the bit rates of the data decoded by the variable length decoding unit 201 and the bit rates of the data coded by the variable length coding unit 202.

In this way, since the open-loop coding rate converting apparatus 200 decodes a stream to the level of inversely quantized orthogonal transform coefficients instead of decoding the input stream to the image level, orthogonal transform and motion compensation predictive coding can be eliminated. Therefore, the coding rate converting apparatus 200 can perform rate conversion at low costs.

However, the coding rate converting apparatus 200 entails the following problem.

In MPEG-2, an MPEG header includes a syntax element indicating whether all the orthogonal transform coefficients are 0 or not for each unit block on which orthogonal transform is performed. Thus, MB headers must be updated each time a block where all the orthogonal transform coefficients become 0 occurs through rate conversion. This produces a problem that the processing performed by the coding rate converting apparatus 200 becomes complex.

A coding rate converting apparatus which solves this problem is disclosed in Patent Reference: Japanese Patent No. 3770466.

FIG. 5 is a block diagram showing the structure of the coding rate converting apparatus disclosed in the above-identified Patent Reference.

The coding rate converting apparatus 300 in FIG. 5 is intended for utilizing, in MPEG-2, an open-loop coding rate converting method. The coding rate converting apparatus 300 includes a variable length decoding unit 301, a variable length coding unit 302, a rate control unit 303, a Q-value transform unit 304, a header storage unit 305, an inverse quantization unit 306, a quantization unit 307, a zero coefficient block detecting unit 308, and a coefficient correcting unit 309.

Note that the variable length decoding unit 301, the variable length coding unit 302, the rate control unit 303, the Q-value transform unit 304, the header storage unit 305, the inverse quantization unit 306, and the quantization unit 307 correspond to the variable length decoding unit 201, the variable length coding unit 202, the rate control unit 203, the Q-value transform unit 204, the header storage unit 205, the inverse quantization unit 206, and the quantization unit 207 shown in FIG. 4, respectively, and thus descriptions for these units are omitted.

The coefficient correcting unit 309 holds orthogonal transform coefficients quantized by the quantization unit 307.

The zero coefficient block detecting unit 308 detects whether all the orthogonal transform coefficients in one block quantized by the quantization unit 307 are 0 or not. In the case where the zero coefficient block detecting unit 308 detects a block where all the quantized orthogonal transform coefficients are 0, it directs the coefficient correcting unit 309 to keep one of the orthogonal transform coefficients as “1” or “−1”. With this direction, the coding rate converting apparatus 300 prevents all the orthogonal transform coefficients in one block from becoming 0 due to rate conversion.

However, in H. 264/AVC, applying the coding rate converting apparatus 200 shown in FIG. 4 produces a problem that a filter intensity in deblocking filtering changes due to rate conversion.

More specifically, such problem occurs in the case where a block boundary has a bS of 2 before rate conversion and the bS 2 is changed to bS 1 or bS 0 through the rate conversion when a block where all the orthogonal transform coefficients in a unit block become 0 occurs due to the rate conversion. As shown in FIG. 3, to set a bS of 2, a non-zero orthogonal transform coefficient must be included in a current block or an adjacent block. Here is an example case where a current block includes a non-zero coefficient before rate conversion, an adjacent block does not include a non-zero coefficient, and the bS is 2. In this case, when all the non-zero coefficients in the current block become 0 through rate conversion, bS 2 is changed to bS 1 or bS 0.

As described above, a bS is a parameter for specifying a filter intensity in the deblocking filtering. There is a problem that block distortion in reproduced pictures in a rate-converted stream becomes greater as the value of a bS becomes smaller due to the rate conversion, deteriorating the picture quality.

This problem that image quality deteriorates due to changes in bS values can be solved by applying, to H. 264, the structure of the coding rate converting apparatus 300 in the Patent Reference, but this produces another problem described below.

The coding rate converting apparatus 300 makes correction so that a non-zero coefficient is kept in each of the blocks where all the orthogonal transform coefficients after the re-quantization are 0.

In the present Application, “to re-quantize quantized data (quantized orthogonal transform coefficients)” is to restore the quantized data into orthogonal transform coefficients and to re-quantize the restored orthogonal transform coefficients. For example, to generate orthogonal transform coefficients by inversely quantizing quantized data and to re-quantize the generated orthogonal transform coefficients is simply referred to as re-quantizing the quantized data. Further, to perform, on a stream, variable length decoding, inverse quantization, forward quantization and variable length coding is simply referred to as re-quantizing the stream.

However, bSs for some block boundaries may not change even when all the non-zero coefficients become 0 through the re-quantization. Examples of such block boundaries for which bSs do not change even when all the non-zero coefficients become zero due to re-quantization include: a block boundary specified as not subjected to deblocking filtering performed to the level of any syntax element, in a hierarchical layer, higher than MB in a stream; and a block boundary for which it has been determined that the bS does not change based on an adjacent block information.

The coding rate converting apparatus 300 makes correction so that at least one non-zero coefficient is always kept even in a block having a block boundary with a constant bS. More specifically, even non-zero coefficients in stream data which never cause deterioration in picture quality due to change in filter intensity are always kept in a rate-converted stream. Accordingly, applying the coding rate converting apparatus 300 to H. 264/AVC produces a problem that coding efficiency in rate conversion is deteriorated.

### SUMMARY OF THE INVENTION

To solve these problems, the present invention has an object to provide a coding rate converting apparatus, integrated circuit, and method, and a program for the same which make it possible to suppress deterioration in picture quality due to rate conversion and increase coding efficiency.

In order to achieve the above object, a coding rate converting apparatus according to the present invention re-quantizes first quantized data, which has been quantized using a first quantization step size, using a second quantization step size greater than the first quantization step size, and the coding rate converting apparatus includes: an inverse quantization unit which generates orthogonal transform coefficients by inversely quantizing the first quantized data for each of unit blocks; a quantization unit which generates second quantized data by quantizing the orthogonal transform coefficients using the second quantization step size; a filter intensity change judging unit which judges whether or not a second filter intensity determined based on the second quantized data is changed from a first filter intensity determined based on the first quantized data; and a coefficient correcting unit which generates, in the case of the second filter intensity changed from the first filter intensity, third quantized data by correcting the second quantized data so that a third filter intensity determined based on the third quantized data becomes equal to the first filter intensity.

With this structure, the coding rate converting apparatus according to the present invention corrects second quantized data obtained by re-quantizing first quantized data so that a filter intensity in deblocking filtering does not change through rate conversion. Thus, the coding rate converting apparatus can suppress deterioration in picture quality due to rate conversion because the filter intensity in deblocking filtering does not change through the rate conversion.

Further, the coding rate converting apparatus judges whether or not a filter intensity in deblocking filtering changes through rate conversion, and in the case where the filter intensity changes, corrects the second quantized data. Thus, the coding rate converting apparatus can suppress deterioration in coding efficiency due to possible unnecessary correction because the second quantized data is not corrected in the case where the filter intensity does not change, and therefore can increase coding efficiency.

In addition, in the coding rate converting apparatus according to a first aspect of the present invention, the filter intensity change judging unit may judge that the second filter intensity is changed from the first filter intensity in the case where the number of non-zero coefficients included in the first quantized data is greater than the first predetermined number of non-zero coefficients and where the number of non-zero coefficients included in the second quantized data is smaller than the first predetermined number of non-zero coefficients, and the coefficient correcting unit may correct the number of non-zero coefficients included in the second quantized data to the number of non-zero coefficients greater than the first predetermined number of non-zero coefficients so as to generate the third quantized data.

With this structure, the coding rate converting apparatus according to the present invention can suppress deterioration in picture quality due to rate conversion and increase coding efficiency in the case where a filter intensity changes depending on the number of non-zero coefficients included in the first and second quantized data.

In addition, in the coding rate converting apparatus according to a second aspect of the present invention, the filter intensity change judging unit may further include: a first judging unit which judges whether or not the first quantized data of a current unit block includes a non-zero coefficient; a second judging unit which judges whether or not the second quantized data of the current unit block includes a non-zero coefficient; a third judging unit which judges whether or not the first quantized data of an adjacent unit block adjacent to the current unit block includes a non-zero coefficient; and a fourth judging unit which judges whether or not the third quantized data of the adjacent unit block includes a non-zero coefficient, and wherein the filter intensity change judging unit may judge that the second filter intensity is changed from the first filter intensity in the case where at least one of the first and third judging units judges that a non-zero coefficient is included and where the second and fourth judging units judge that a non-zero coefficient is not included.

With this structure, the coding rate converting apparatus according to the present invention does not correct the second quantized data in the case where a filter intensity does not change even when a non-zero coefficient is not included in the second quantized data after rate conversion. Thus, the coding rate converting apparatus can increase coding efficiency.

In addition, in the coding rate converting apparatus according to a third aspect of the present invention, the coefficient correcting unit may generate the third quantized data by replacing, with a non-zero coefficient, at least one of quantized orthogonal transform coefficients included in the second quantized data.

With this structure, the coding rate converting apparatus according to the present invention can correct the second quantized data so that a filter intensity does not change through rate conversion.

In addition, in the coding rate converting apparatus according to a fourth aspect of the present invention, the coefficient correcting unit may replace, with a non-zero coefficient, a highest frequency coefficient from among quantized orthogonal transform coefficients included in the second quantized data.

With this structure, the coding rate converting apparatus according to the present invention can suppress deterioration in coding efficiency and picture quality due to correction of the second quantized data.

In addition, in the coding rate converting apparatus according to a fifth aspect of the present invention, the coefficient correcting unit may replace, with 1, the highest frequency coefficient.

With this structure, the coding rate converting apparatus according to the present invention can suppress deterioration in coding efficiency and picture quality due to correction of the second quantized data.

In addition, in the coding rate converting apparatus according to the second aspect of the present invention, the filter intensity change judging unit may further include a fifth judging unit which judges whether or not at least one of a current unit block and an adjacent unit block adjacent to the current unit block belongs to a macroblock on which intra-prediction is performed, and the filter intensity change judging unit may judge that the second filter intensity is not changed from the first filter intensity in the case where said fifth judging unit judges that at least one of the current unit block and the adjacent unit block belongs to the macroblock on which the intra-prediction is performed.

With this structure, the coding rate converting apparatus according to the present invention does not correct the second quantized data in the case where a filter intensity does not change even when a non-zero coefficient is not included in the second quantized data after rate conversion. Thus, the coding rate converting apparatus can increase coding efficiency.

In addition, in the coding rate converting apparatus according to the second aspect of the present invention, the filter intensity change judging unit may further include a sixth judging unit which judges whether or not filtering is executed on the current unit block, and the filter intensity change judging unit may judge that the second filter intensity is not changed from the first filter intensity in the case where said sixth judging unit judges that filtering is not executed on the current unit block.

With this structure, the coding rate converting apparatus according to the present invention does not correct the second quantized data in the case where a filter intensity does not change even when a non-zero coefficient is not included in the second quantized data after rate conversion. Thus, the coding rate converting apparatus can increase coding efficiency.

In addition, a coding rate converting apparatus according to the present invention re-quantizes first quantized data, which has been quantized using a first quantization step size, using a second quantization step size larger than the first quantization step size, and the coding rate converting apparatus includes: an inverse quantization unit which generates orthogonal transform coefficients by inversely quantizing the first quantized data for each of unit blocks; a quantization unit which generates second quantized data by quantizing the orthogonal transform coefficients using the second quantization step size; a coefficient correcting unit which generates third quantized data by replacing, with a non-zero coefficient, each of at least one of quantized orthogonal transform coefficients included in the second quantized data; a first judging unit which judges whether or not the first quantized data of a current unit block includes a non-zero coefficient; a second judging unit which judges whether or not the second quantized data of the current unit block includes a non-zero coefficient; a third judging unit which judges whether or not the first quantized data of an adjacent unit block adjacent to the current unit block includes a non-zero coefficient; and a fourth judging unit which judges whether or not the third quantized data of the adjacent unit block includes a non-zero coefficient, and wherein the coefficient correcting unit generates third quantized data by replacing, with a non-zero coefficient, each of the at least one of the quantized orthogonal transform coefficients included in the second quantized data in the case where at least one of the first and third judging units judges that a non-zero coefficient is included and where the second and fourth judging units judge that a non-zero coefficient is not included.

With this structure, the coding rate converting apparatus according to the present invention corrects second quantized data so that a filter intensity in deblocking filtering does not change through rate conversion. Thus, the coding rate converting apparatus can suppress deterioration in picture quality due to rate conversion because the filter intensity in deblocking filtering does not change through the rate conversion.

Further, the coding rate converting apparatus according to the present invention does not correct the second quantized data in the case where a filter intensity does not change even when a non-zero coefficient is not included in the second quantized data after rate conversion. Thus, the coding rate converting apparatus can increase coding efficiency.

In addition, an integrated circuit according to the present invention re-quantizes first quantized data, which has been quantized using a first quantization step size, using a second quantization step size larger than the first quantization step size, and the integrated circuit includes: an inverse quantization unit which generates orthogonal transform coefficients by inversely quantizing the first quantized data for each of unit blocks; a quantization unit which generates second quantized data by quantizing the orthogonal transform coefficients using the second quantization step size; a filter intensity change judging unit which judges whether or not a second filter intensity determined based on the second quantized data is changed from a first filter intensity determined based on the first quantized data; and a coefficient correcting unit which generates, in the case of the second filter intensity changed from the first filter intensity, third quantized data by correcting the second quantized data so that a third filter intensity determined based on the third quantized data becomes equal to the first filter intensity.

With this structure, the coding rate converting integrated circuit according to the present invention corrects second quantized data so that a filter intensity in deblocking filtering does not change through rate conversion. Thus, the coding rate converting integrated circuit can suppress deterioration in picture quality due to rate conversion because the filter intensity in deblocking filtering does not change through the rate conversion.

Further, the coding rate converting integrated circuit judges whether or not a filter intensity in deblocking filtering changes through rate conversion, and in the case where the filter intensity changes, corrects the second quantized data. Thus, the coding rate converting integrated circuit can suppress deterioration in coding efficiency due to possible unnecessary correction because the second quantized data is not corrected in the case where the filter intensity does not change, and therefore can increase coding efficiency.

In addition a coding rate converting method according to the present invention is intended for re-quantizing first quantized data, which has been quantized using a first quantization step size, using a second quantization step size larger than the first quantization step size, and the coding rate converting method includes: generating orthogonal transform coefficients by inversely quantizing the first quantized data for each of unit blocks; generating second quantized data by quantizing the orthogonal transform coefficients using the second quantization step size; judging whether or not a second filter intensity determined based on the second quantized data is changed from a first filter intensity determined based on the first quantized data; and generating, in the case of the second filter intensity changed from the first filter intensity, third quantized data by correcting the second quantized data so that a third filter intensity determined based on the third quantized data becomes equal to the first filter intensity.

With this structure, in the coding rate converting method according to the present invention, second quantized data is corrected so that a filter intensity in deblocking filtering does not change through rate conversion. Thus, the coding rate converting method makes it possible to suppress deterioration in picture quality due to rate conversion because the filter intensity in deblocking filtering does not change through the rate conversion.

Further, in the coding rate converting method, a judgment on whether or not a filter intensity in deblocking filtering changes through rate conversion is made, and in the case where the filter intensity changes, the second quantized data is corrected. Thus, the coding rate converting method makes it possible to suppress deterioration in coding efficiency due to possible unnecessary correction because the second quantized data is not corrected in the case where the filter intensity does not change, and therefore to increase coding efficiency.

In addition, a stream recording apparatus according to the present invention records a coded stream, and includes: a variable length decoding unit which generates first quantized data which has been quantized using a first quantization step size by variable length decoding the coded stream; an inverse quantization unit which generates orthogonal transform coefficients by inversely quantizing the first quantized data for each of unit blocks; a quantization unit which generates second quantized data by re-quantizing the orthogonal transform coefficients using the second quantization step size larger than the first quantization step size; a filter intensity change judging unit which judges whether or not a second filter intensity determined based on the second quantized data is changed from a first filter intensity determined based on the first quantized data; a coefficient correcting unit which generates, in the case where the second filter intensity is changed from the first filter intensity, third quantized data by correcting the second quantized data so that a third filter intensity determined based on the third quantized data becomes equal to the first filter intensity; a variable length coding unit which generates coded data by variable length coding the third quantized data; and a storage unit in which the coded data is stored.

With this structure, the stream recording apparatus according to the present invention can suppress deterioration in picture quality due to rate conversion of coded data to be recorded. In addition, the stream recording apparatus according to the present invention makes it possible to increase the coding efficiency in rate conversion, and thus more contents can be stored.

In addition, a network distribution system according to the present invention is intended for distributing a coded first stream via a network, and includes a transmitting apparatus which transmits the first stream and a receiving apparatus which receives the first stream transmitted by the transmitting apparatus. The transmitting apparatus includes: a variable length decoding unit which generates first quantized data which has been quantized using a first quantization step size by variable length decoding a second coded stream; an inverse quantization unit which generates orthogonal transform coefficients by inversely quantizing the first quantized data for each of unit blocks; a quantization unit which generates second quantized data by re-quantizing the orthogonal transform coefficients using the second quantization step size larger than the first quantization step size; a filter intensity change judging unit which judges whether or not a second filter intensity determined based on the second quantized data that the receiving apparatus uses in deblocking filtering for reducing noises at the boundaries of unit blocks is changed from a first filter intensity determined based on the first quantized data; a coefficient correcting unit which generates, in the case where the second filter intensity is changed from the first filter intensity, third quantized data by correcting the second quantized data so that a third filter intensity determined based on the third quantized data becomes equal to the first filter intensity; a variable length coding unit which generates the first coded stream by variable length coding the third quantized data; and a transmitting unit which transmits the first coded stream via the network.

With this structure, the network distribution system according to the present invention makes it possible to suppress quality deterioration of pictures in a stream to be distributed. In addition, the stream recording apparatus according to the present invention can increase coding efficiency in rate conversion, and thus can reduce the data amount of the stream to be distributed.

Note that the present invention can be realized not only as such coding rate converting apparatus, but also as a coding rate converting method having steps corresponding to the unique units included in the coding rate converting apparatus and a program causing a computer to execute such unique steps. In addition, such program can be distributed via recording media such as CD-ROMs and communication media such as the Internet.

As described above, the present invention can provide a coding rate converting apparatus, integrated circuit, and method, and a program for the same which make it possible to suppress deterioration in picture quality due to rate conversion and increase coding efficiency.

### FURTHER INFORMATION ABOUT TECHNICAL BACKGROUND TO THIS APPLICATION

The disclosure of Japanese Patent Application No. 2007-111276 filed on Apr. 20, 2007 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram showing the structure of an H. 264/AVC decoding apparatus;

FIG. 2 is a conceptual diagram of deblocking filtering;

FIG. 3 is a diagram showing a method for determining a filter intensity in deblocking filtering based on a satisfied condition among the listed conditions;

FIG. 4 is a block diagram showing the structure of a conventional coding rate converting apparatus;

FIG. 5 is a block diagram showing the structure of a conventional coding rate converting apparatus;

FIG. 6 is a block diagram showing the structure of a coding rate converting apparatus according to a first embodiment of the present invention;

FIG. 7 is a flowchart showing processing performed by a coding rate converting apparatus according to the first embodiment of the present invention;

FIG. 8A is a diagram showing a sequence of processing steps on luminance blocks performed by the coding rate converting apparatus according to the first embodiment of the present invention;

FIG. 8B is a diagram showing a sequence of processing steps on luminance blocks performed by the coding rate converting apparatus according to the first embodiment of the present invention;

FIG. 9 is a flowchart showing processing performed by the filter intensity judging unit according to the first embodiment of the present invention;

FIG. 10 is a diagram showing conditions for judging whether or not a filter intensity is changed and the results of the judgments made by the coding rate converting apparatus according to the first embodiment of the present invention;

FIG. 11 is a diagram showing an example of operations performed by the coding rate converting apparatus according to the first embodiment of the present invention;

FIG. 12 is a diagram showing an example of operations performed by the coding rate converting apparatus according to the first embodiment of the present invention;

FIG. 13 is a block diagram showing the structure of a stream recording apparatus according to a second embodiment of the present invention; and

FIG. 14 shows a block diagram showing the structure of a network distribution system according to a third embodiment of the present invention.

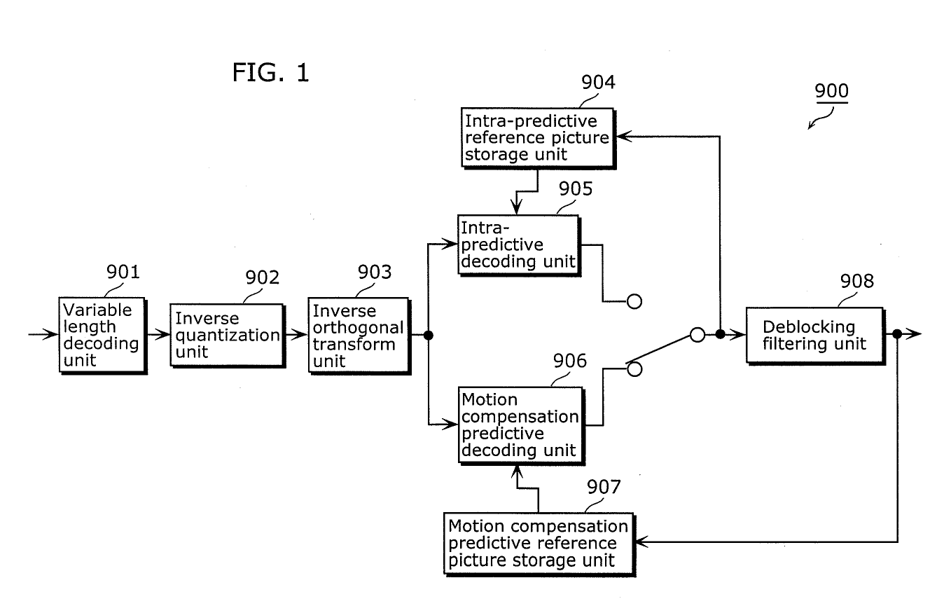

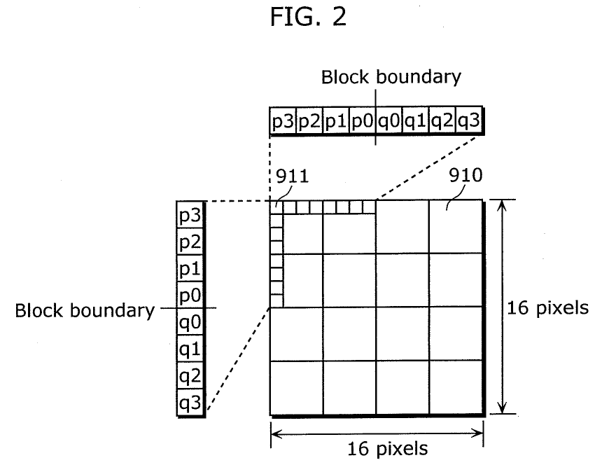

### DESCRIPTION OF THE PREFERRED EMBODIMENT(S)

Coding rate converting apparatuses according to embodiments of the present invention will be described in detail below with reference to the drawings.

### First Embodiment

A coding rate converting apparatus according to a first embodiment of the present invention corrects quantized orthogonal transform coefficients having a converted coding rate only when the filter intensity is changed in deblocking filtering. Thus, the coding rate converting apparatus according to the first embodiment of the present invention can suppress deterioration in picture quality due to rate conversion and increase coding efficiency.

First, a description is given of the structure of the coding rate converting apparatus according to the first embodiment of the present invention.

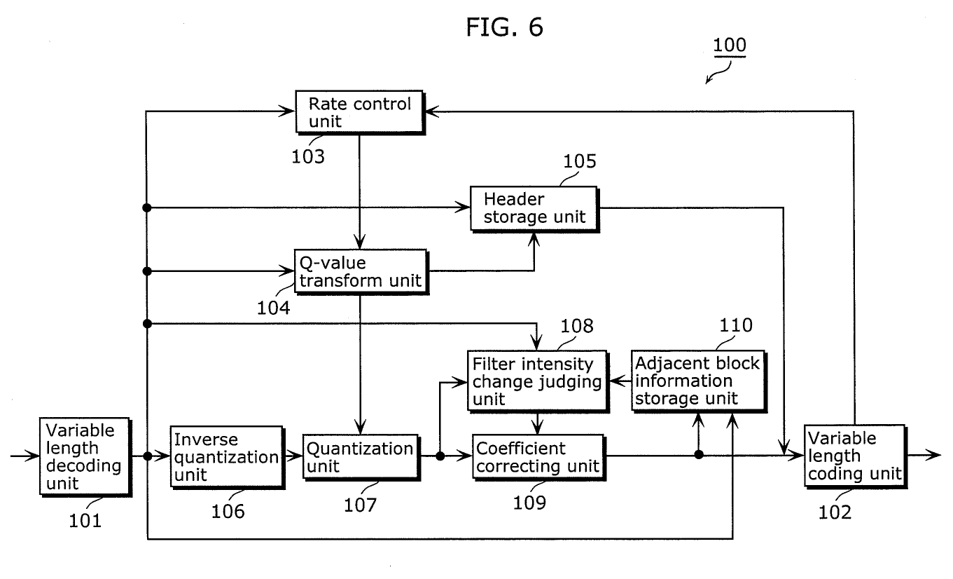

FIG. 6 is a block diagram showing the structure of the coding rate converting apparatus according to the first embodiment of the present invention.

The coding rate converting apparatus in FIG. 6 generates a stream with a changed coding rate by re-quantizing an input stream, which has been quantized using a first quantization step size, using a second quantization step size larger than the first quantization step size.

The coding rate converting apparatus 100 includes a variable length decoding unit 101, a variable length coding unit 102, a rate control unit 103, a Q-value transform unit 104, a header storage unit 105, an inverse quantization unit 106, a quantization unit 107, a filter intensity change judging unit 108, a coefficient correcting unit 109, and an adjacent block information storage unit 110.

The variable length decoding unit 101 generates first quantized data corresponding to quantized orthogonal transform coefficients and MB headers corresponding to MB data other than the first quantized data by decoding an input stream. Here, the input stream is an H. 264/AVC stream quantized using the first quantization step size and variable length coded.

The variable length decoding unit 101 outputs parameters included in MB headers to the header storage unit 105, and outputs the first quantization step size included in the MB headers to the Q-value transform unit 104. In addition, the variable length decoding unit 101 outputs the generated first quantized data to the inverse quantization unit 106.

In addition, the variable length decoding unit 101 outputs current block information to the adjacent block information storage unit 110 as the information for judging change in filter intensity in the succeeding blocks. Further, the variable length decoding unit 101 outputs the bit amount of a decoded stream to the rate control unit 103.

The rate control unit 103 corrects, as necessary, target bit rates based on the bit amount outputted by the variable length decoding unit 101 and the bit amount outputted by the variable length decoding unit 102. In addition, the rate control unit 103 calculates target quantization step sizes according to target bit rates, and outputs the calculated target quantization step sizes to the Q-value transform unit 104.

The Q-value transform unit 104 determines a second quantization step size corresponding to a new quantization step size for output, using the first quantization step size outputted by the variable length decoding unit 101 and a target quantization step size outputted by the Q-value transform unit 104. The Q-value transform unit 104 outputs the determined second quantization step size to the quantization unit 107 and the header storage unit 105.

The header storage unit 105 rewrites the first quantization step size included in MB headers to the second quantization step size determined by the Q-value transform unit 104. The header storage unit 105 outputs the updated MB headers to the variable length coding unit 102.

The inverse quantization unit 106 generates orthogonal transform coefficients by inversely quantizing the first quantized data using the first quantization step size. The inverse quantization unit 106 outputs the generated orthogonal transform coefficients to the quantization unit 107.

The quantization unit 107 generates second quantized data corresponding to the quantized orthogonal transform coefficients by quantizing the orthogonal transform coefficients outputted by the inverse quantization unit 106 using the second quantization step size determined by the Q-value transform unit 104. The quantization unit 107 outputs the generated second quantized data to the coefficient correcting unit 109 and the filter intensity change judging unit 108.

The filter intensity change judging unit 108 judges whether or not the first filter intensity determined based on the first quantized data changes to the second filter intensity determined based on the second quantized data in deblocking filtering, based on the first quantized data outputted by the variable length decoding 101, the second quantized data outputted by the quantization unit 107, and adjacent block information outputted by the adjacent block information storage unit 110. In other words, the filter intensity change judging unit 108 judges whether or not the first filter intensity determined based on the first quantized data is equal to the second filter intensity determined based on the second quantized data. When the second filter intensity is different from the first filter intensity; that is, when a filter intensity is changed through rate conversion, the filter intensity change judging unit 108 directs the coefficient correcting unit 109 to correct the second quantized data.

The coefficient correcting unit 109 corrects the second quantized data outputted by the quantization unit 107 according to the direction from the filter intensity change judging unit 108 so that the second filter intensity becomes equal to the first filter intensity. In other words, the coefficient correcting unit 109 corrects the second quantized data so that the filter intensity does not change through the rate conversion. The coefficient correcting unit 109 outputs third quantized data corresponding to the corrected orthogonal transform coefficients to the variable length coding unit 102 and adjacent block information storage unit 110.

The adjacent block information storage unit 110 stores the third quantized data outputted by the coefficient correcting unit 109. The adjacent block information storage unit 110 outputs the third quantized data to be stored to the filter intensity change judging unit 108 as the adjacent block information for the succeeding blocks.

More specifically, the adjacent block information storage unit 110 stores the following information as the adjacent block information.

Such information is categorized into the following three: information indicating whether or not the MB including a current block is an intra-predictive coded MB (intra MB); information indicating whether or not adjacent blocks before re-quantization includes a non-zero coefficient; and information indicating whether the adjacent blocks after the re-quantization includes a non-zero coefficient.

The variable length coding unit 102 generates a stream with a changed coding rate by performing variable length coding on the MB headers outputted by the header storage unit 105 and the third quantized data outputted by the coefficient correcting unit 109.

Next, a description is given of operations of the coding rate converting apparatus 100.

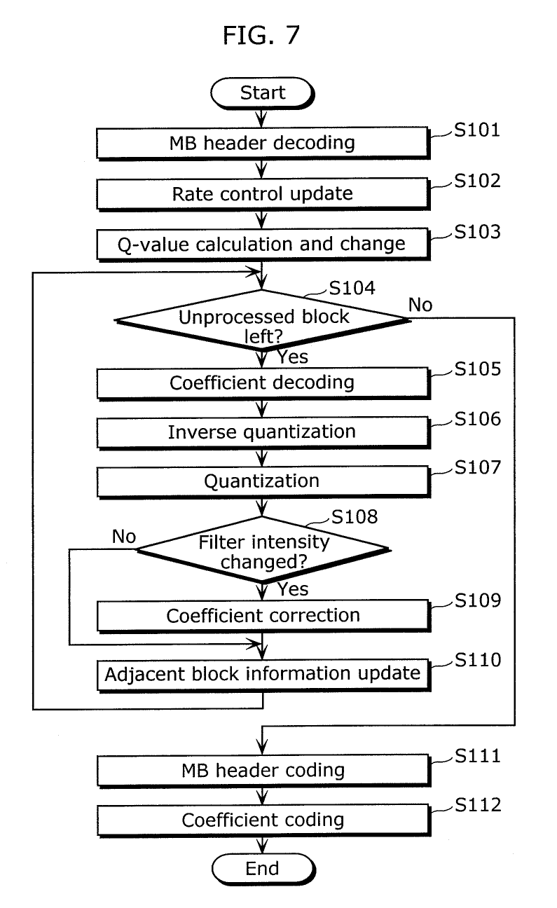

FIG. 7 is a flowchart showing processing performed by the coding rate converting apparatus 100. Note that FIG. 7 shows the operations for converting the coding rate of single MB data.

First, the variable length decoding unit 101 decodes the MB header in an input stream, and stores the decoding result in the header storage unit 105 (S101).

Next, the rate control unit 103 updates an internal rate control buffer based on the decoding bit amount and coding bit amount before the MB, and calculates a target quantization step size (S102).

Here, while it is good to directly use the calculated target quantization step size as the second quantization step size for output in the case of a coding apparatus, it is not always good to use the calculated target quantization step size for output in the case of a coding rate converting apparatus. For example, it is obvious that the picture quality of an output steam cannot be improved compared with that of the input stream in the case where the second quantization step size smaller than the first quantization step size is assigned to an MB for which the larger first quantization step size has been specified for input.

For this reason, the Q-value transform unit 104 calculates the second quantization step size with reference to the first quantization step size instead of directly using the target quantization step size as the second quantization step size. The Q-value transform unit 104 rewrites the quantization step size stored in the header storage unit 105 to the calculated second quantization step size (S103).

Next, the coding rate converting apparatus 100 checks the number of blocks to be processed. In addition, the coding rate converting apparatus 100 judges whether or not all the blocks included in the MB have been processed (S104).

Here, when a chrominance format is 4:2:0, a single MB includes a luminance block of 16×16 pixels and two chrominance blocks of 8×8 pixels. Thus, a unit block in deblocking filtering is a 4×4 block, the single MB includes 16 luminance blocks and 8 chrominance blocks.

In the case where all the blocks included in the MB has been processed (No in S104), the coding rate converting apparatus 100 finishes the rate conversion for the MB. The variable length coding unit 102 codes the MB header (S111) and codes the third quantized data (S112), and finishes the processing on the MB.

The opposite case where at least one unprocessed block is left (Yes in S104), the variable length decoding unit 101 generates the first quantized data corresponding to a current block by decoding the input stream next (S105). The inverse quantization unit 106 generates orthogonal transform coefficients by inversely quantizing the first quantized data (S106). The quantization unit 107 generates the second quantized data by quantizing the orthogonal transform coefficients using the second quantization step size (S107).

Next, the filter intensity change judging unit 108 judges whether or not a filter intensity changes due to changing the quantization step sizes (S108). Here, deblocking filtering on the chrominance blocks is performed using bSs for the luminance blocks. In other words, the bSs of the chrominance blocks never change due to re-quantization of chrominance blocks. Thus, the filter intensity change judging unit 108 makes a judgment on whether a filter intensity changes for the luminance blocks only, and judges that a filter intensity for chrominance blocks never changes.

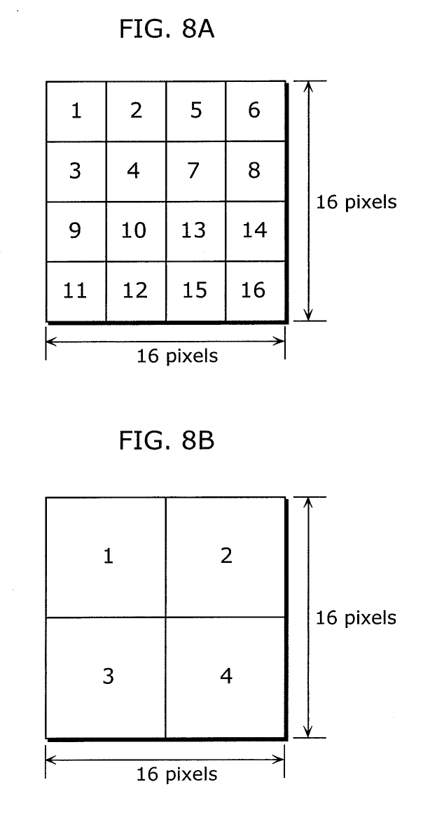

FIGS. 8A and 8B are diagrams showing a sequence of processing on luminance blocks of 4×4 blocks and 8×8 blocks.

The filter intensity change judging unit 108 makes a judgment on whether a filter intensity changes for the top and left block boundaries of the current block. The filter intensity change judging unit 108 judges that the filter intensity for the luminance blocks changes in the case where the filter intensity of either the top block boundary or the left block boundary changes.

The following is a detailed description given of a judgment on a filter intensity change made by the filter intensity change judging unit 108.

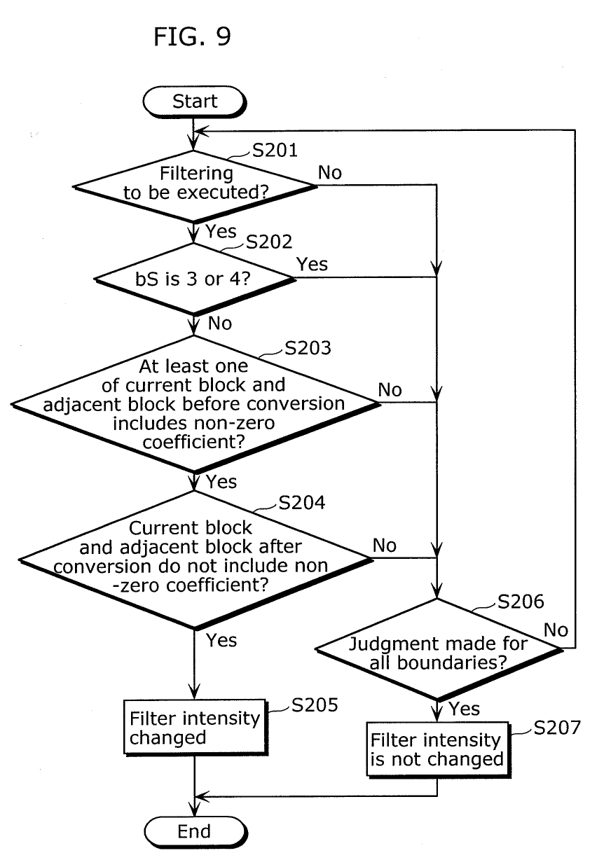

FIG. 9 is a flowchart showing the judgment on a filter intensity change made by the filter intensity change judging unit 108.

First, the filter intensity change judging unit 108 makes such judgment for either the top boundary or the left boundary from among the block boundaries of the current block.

The filter intensity change judging unit 108 judges whether or not deblocking filtering is performed on the block boundary (S201). More specifically, the filter intensity change judging unit 108 judges whether a parameter for determining whether deblocking filtering should be performed on the block boundary specifies “execution” or not.

Here, as disclosed in the Non-patent Reference, whether deblocking filtering should be executed on a current block boundary is specified depending on the following three flags: a filterInternalEdgeFlag, filterLeftMbEdgeFlag, and filterTopMbEdgeFlag. The filterInternalEdgeFlag is for specifying whether a filter should be applied to a block boundary which is not an MB boundary; filtering is executed when this flag is 1, but filtering is not executed when this flag is 0. The filterLeftMbEdgeFlag is for specifying whether a filter should be applied to a block boundary which is a left boundary of an MB; filtering is executed when this flag is 1, but filtering is not executed when this flag is 0. The filterTopMbEdgeFlag is for specifying whether a filter should be applied to a block boundary which is a top boundary of an MB; filtering is executed when this flag is 1, but filtering is not executed when this flag is 0.

The filter intensity change judging unit 108 selects and refers to a corresponding flag based on the location of the block boundary with respect to a current MB, and judges as “execution” when the flag is 1. For example, the top boundary of a block 3 in FIG. 8A is a block boundary which is not an MB boundary, the filter intensity change judging unit 108 refers to the filterInternalEdgeFlag, and judges as “execution” when the flag is 1.

When the filter intensity change judging unit 108 judges the execution of filtering (Yes in S201), it judges whether a condition that the bS of the block boundary is 3 or 4 is satisfied or not next (S202). In other words, the filter intensity change judging unit 108 judges whether at least one of the current block and an adjacent block belongs to an intra-MB.

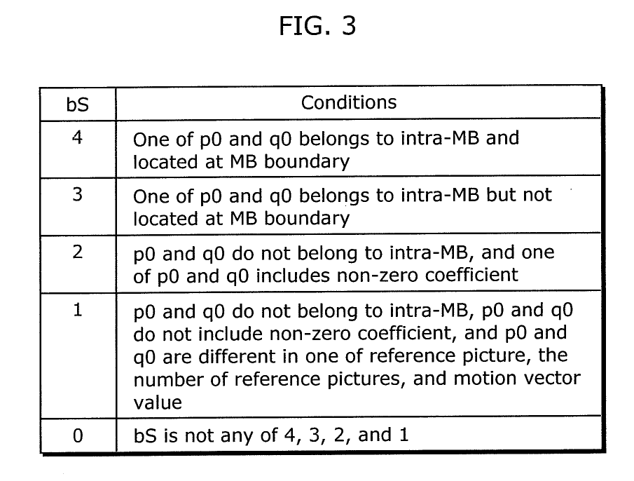

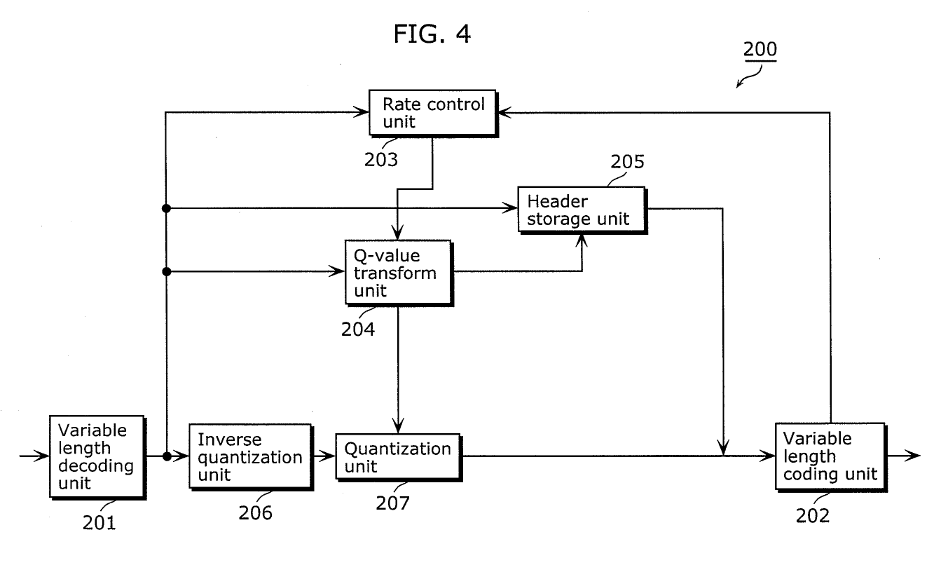

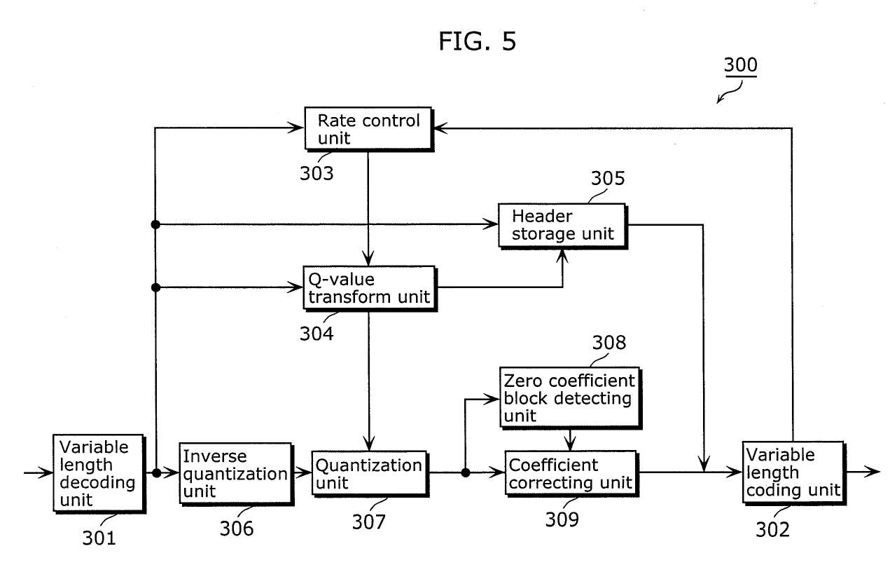

Here, in the case where the block boundary satisfies the condition that the bS is 3 or 4 as shown in FIG. 3, the bS never changes due to re-quantization.

The filter intensity change judging unit 108 judges whether at least one of the current block and the adjacent block belongs to the intra-MB, using current block information (information indicating whether the current block belongs to an intra-MB) and adjacent block information (information indicating whether the adjacent block belongs to an intra-MB) held in the adjacent block information storage unit 110.

When the condition that the bS is 3 or 4 is not satisfied (No in S202), the filter intensity change judging unit 108 judges whether at least one of the current block and the adjacent block before rate conversion includes a non-zero coefficient or not next (S203).

Further, when at least one of the current block and the adjacent block before rate conversion includes a non-zero coefficient (Yes in S203), the filter intensity change judging unit 108 judges whether the current block and the adjacent block after rate conversion do not include a non-zero coefficient (S204). The filter intensity change judging unit 108 makes judgments of Steps S203 and S204 based on the adjacent block information held in the adjacent block information storage unit 110.

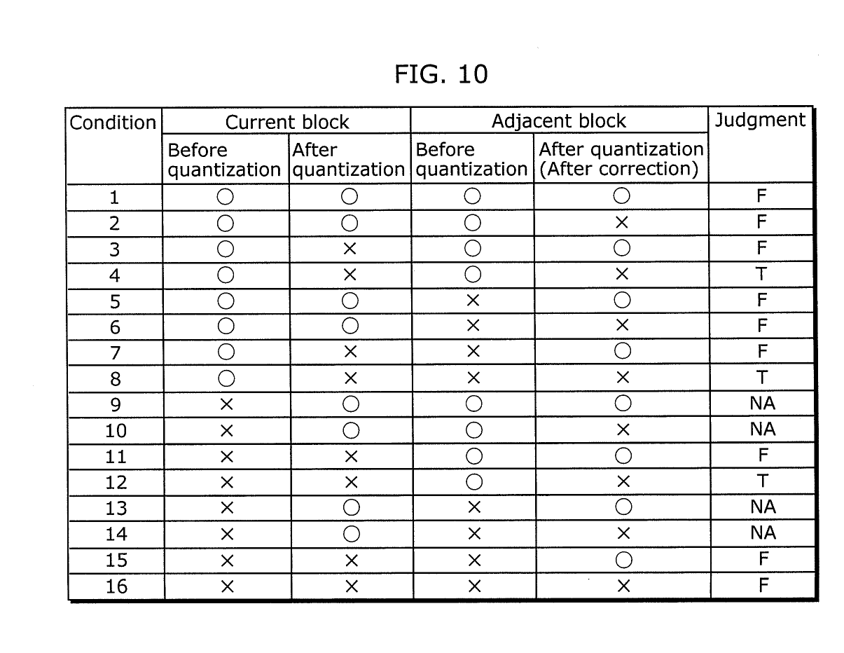

FIG. 10 is a diagram showing the results of judgments made, by the filter intensity change judging unit 108, as to such conditions for the current block and the adjacent block before and after the rate conversion.

In FIG. 10, “∘” indicates that a non-zero coefficient is included, and “x” indicates that non-zero coefficient is not included. In addition, in FIG. 10, when a final judgment is “T”, the judgment in Step S203 is Yes and the judgment in Step S204 is Yes.

For example, a condition 8 in FIG. 10 indicates that an adjacent block does not include a non-zero coefficient before and after rate conversion, and that a current block includes a non-zero coefficient before the rate conversion, but does not include any non-zero coefficient after the rate conversion (all the orthogonal transform coefficients become 0). In this case, since the bS becomes 1 or 0 though the conversion when the bS before the rate conversion is 2, the filter intensity change judging unit judges as “T”. Note that the conditions judged as “NA” in FIG. 10 never be satisfied in reality because the conditions defining that a non-zero coefficient is not included before rate conversion and that a non-zero coefficient is included after the rate conversion.

The filter intensity change judging unit 108 judges that a filter intensity changes for a current block boundary through rate conversion and that the filter intensity for the current block changes (S205) when at least one of the current block and an adjacent block before the rate conversion includes a non-zero coefficient (Yes in S203) and the current block and the adjacent block after the rate conversion do not include a non-zero coefficient (Yes in Step 204).

On the other hand, the filter intensity change judging unit 108 judges that a filter intensity does not change for the block boundary when: filtering is not executed (No in S201); the bS is 3 or 4 (Yes in S202); the current block and the adjacent block before rate conversion do not include a non-zero coefficient (No in S203); or at least one of the current block and the adjacent block after the rate conversion includes a non-zero coefficient (No in S204).

Next, the filter intensity change judging unit 108 judges whether or not judgments on whether a filter intensity changes have been made for all the block boundaries (S206).

In the case where judgments on filter intensity changes are made for all the block boundaries, that is, the top and left block boundaries (Yes in S206), the filter intensity change judging unit 108 judges that a filter intensity does not change for the current block before and after rate conversion (S207).

In the opposite case where a judgment on a filter intensity change is not made for all the block boundaries (No in S206), the filter intensity change judging unit 108 performs the judgment steps S201 to S204 for the other block boundary.

The following is described with reference to FIG. 7 again.

In the case where the filter intensity change judging unit 108 judges that the filter intensity of the current block changes (Yes in S108), it directs the coefficient correcting unit 109 to correct the second quantized data.

The coefficient correcting unit 109 corrects the second quantized data according to the correction direction by the filter intensity change judging unit 108 (S109). More specifically, the coefficient correcting unit 109 corrects the second quantized data by converting at least one orthogonal transform coefficient to a non-zero coefficient such as “1”.

In the case where the filter intensity change judging unit 108 judges that the filter intensity does not change (No in S108) or after the coefficient correcting unit 109 corrects the second quantized data (S109), the adjacent block information storage unit 110 stores the current block information as the adjacent block information for the succeeding blocks (S110).

When the current block information is stored in the adjacent block information storage unit 110, the coding rate converting apparatus 100 subtracts 1 from the number of blocks to be processed within a current MB, and performs Step S104 and the succeeding steps on the next block.

The following is a description given of a specific example of a judgment on a filter intensity change made by the filter intensity change judging unit 108.

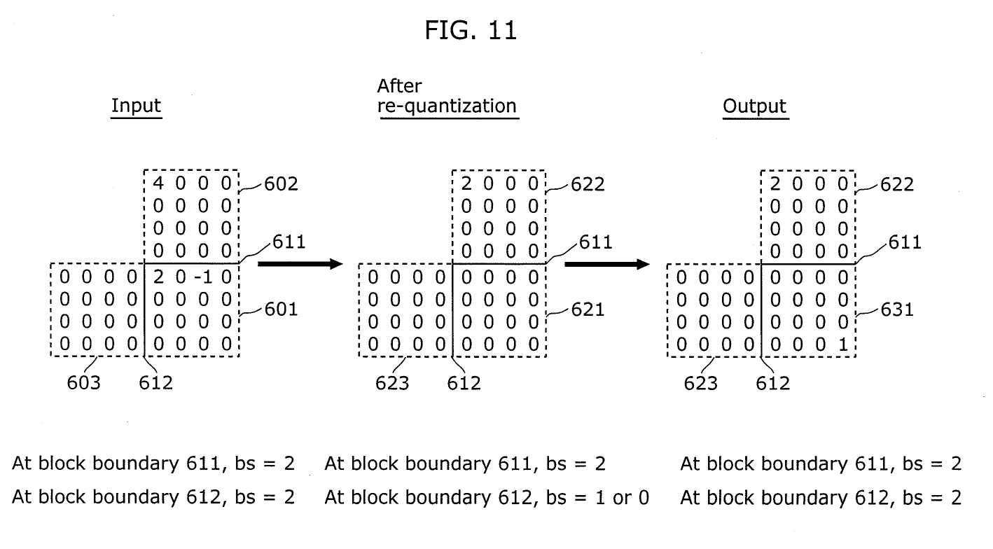

FIG. 11 is a diagram showing an example of the current block and adjacent blocks in the case where a filter intensity changes due to rate conversion.

Here, it is assumed that, in FIG. 11, an inter-MB includes a current block 601, a top adjacent block 602, and a left adjacent block 603, and that all the execution control flags for deblocking filtering on a top block boundary 611 and a left block boundary 612 are 1.

First, the filter intensity change judging unit 108 judges whether a filter intensity changes for the top block boundary 611. The filter intensity change judging unit 108 judges that “filter processing is executed” since all the execution control flags for deblocking filtering are 1 (Yes in S201).

Next, since the current block 601 and the top adjacent block 602 are included in an inter-MB, the filter intensity change judging unit 108 judges that the bS is not 4 or 3 (No in S202).

In addition, the current block 601 before re-quantization includes a non-zero coefficient, the current block 601 after the re-quantization does not include a non-zero coefficient, and adjacent blocks 602 and 622 before and after the re-quantization include a non-zero coefficient. In other words, since a condition 3 in FIG. 10 is satisfied, the filter intensity change judging unit 108 judges as “F” (Yes in S203, and No in S204). Thus, the filter intensity change judging unit 108 judges that a filter intensity does not change for the block boundary 611.

Next, the filter intensity change judging unit 108 judges whether a filter intensity changes for the left block boundary 612. The filter intensity change judging unit 108 judges as “filtering is executed” since all the execution flags for deblocking filtering are 1 (Yes in S201).

Next, the filter intensity change judging unit 108 judges that the bS is not 4 or 3 since the current block 601 and the left adjacent block 603 are included in an inter-MB, the filter intensity change judging unit 108 judges that the bS is not 4 or 3 (No in S202).

In addition, the current block 601 before re-quantization includes a non-zero coefficient, the current block 621 after the re-quantization does not include a non-zero coefficient, and adjacent blocks 603 and 623 before and after the re-quantization does not include a non-zero coefficient. In other words, since a condition 8 in FIG. 10 is satisfied, the filter intensity change judging unit 108 judges as “T” (Yes in S203, and No in S204). Thus, the filter intensity change judging unit 108 judges that a filter intensity changes for the block boundary 612.

Since the filter intensity does not change for the top block boundary 611 but changes for the left block boundary 612 in the current block 601 as described above, the filter intensity change judging unit 108 judges that the filter intensity for the current block 601 “changes”. Thus, the coefficient correcting unit 109 generates a corrected current block 631 by correcting a re-quantized current block 621. In this example, the coefficient correcting unit 109 replaces, with 1, the highest frequency component coefficient in view of coding efficiency and picture quality.

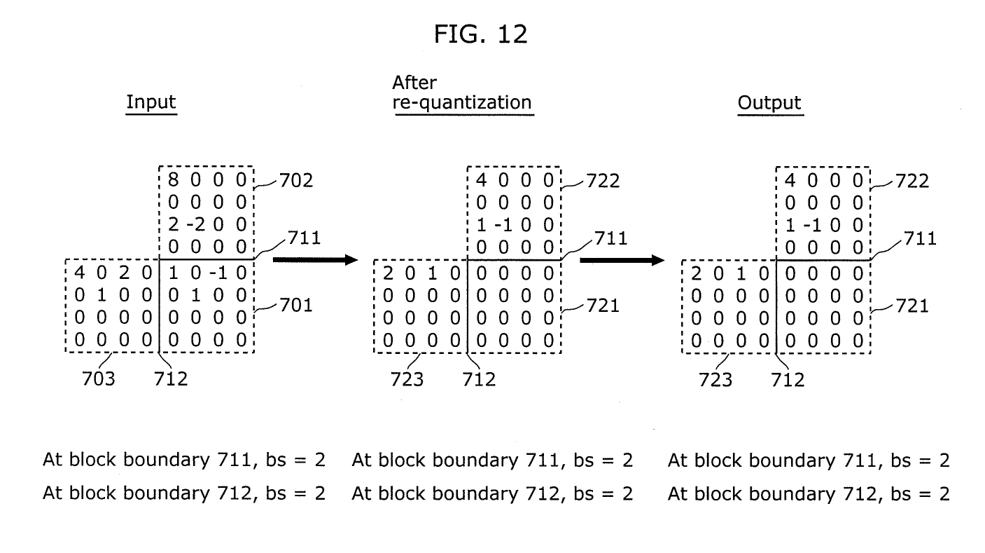

FIG. 12 is a diagram showing an example of a current block and adjacent blocks in the case where a filter intensity does not change due to rate conversion.

Here, it is assumed that, in FIG. 12, an inter-MB includes a current block 701, a top adjacent block 702, and a left adjacent block 703, and that all the execution control flags for deblocking filtering on a top block boundary 711 and a left block boundary 712 are 1.

First, the filter intensity change judging unit 108 judges whether a filter intensity changes for the top block boundary 711. The filter intensity change judging unit 108 judges that “filter processing is executed” since all the execution control flags for deblocking filtering are 1 (Yes in S201).

Next, since the current block 701 and the top adjacent block 702 are included in an inter-MB, the filter intensity change judging unit 108 judges that the bS is not 4 or 3 (No in S202).

In addition, the current block 701 before re-quantization includes a non-zero coefficient, the current block 721 after the re-quantization does not include a non-zero coefficient, and adjacent blocks 702 and 722 before and after the re-quantization include a non-zero coefficient. In other words, since a condition 3 in FIG. 10 is satisfied, the filter intensity change judging unit 108 judges as “F” (Yes in S203, and No in S204). Thus, the filter intensity change judging unit 108 judges that a filter intensity does not change for the block boundary 711.

Next, the filter intensity change judging unit 108 judges whether a filter intensity changes for the left block boundary 712. The filter intensity change judging unit 108 judges as “filtering is executed” since all the execution flags for deblocking filtering are 1 (Yes in S201).

Next, since the current block 701 and the left adjacent block 703 are included in an inter-MB, the filter intensity change judging unit 108 judges that the bS is not 4 or 3 (No in S202).

In addition, the current block 701 before re-quantization includes a non-zero coefficient, the current block 721 after the re-quantization does not include a non-zero coefficient, and adjacent blocks 703 and 723 before and after the re-quantization include a non-zero coefficient. In other words, since a condition 3 in FIG. 10 is satisfied, the filter intensity change judging unit 108 judges as “F” (Yes in S203, and No in S204). Thus, the filter intensity change judging unit 108 judges that a filter intensity changes for the block boundary 712.

Since the filter intensity does not change for the top block boundary 711 and for the left block boundary 712 in the current block 701 as described above, the filter intensity change judging unit 108 judges that the filter intensity for the current block 601 is “not changed”. Thus, the coefficient correcting unit 109 does not correct the re-quantized current block 721.

As shown in the above-described examples of FIGS. 11 and 12, the coding rate converting apparatus 100 judges whether a filter intensity changes based on the current block information and the adjacent block information, and perform controls for correction based on the judgment results. Thus, the coding rate converting apparatus 100 prevents such correction when a filter intensity does not change even in the case where all the coefficients included in a current block are converted to 0 through re-quantization.

As described above, the coding rate converting apparatus 100 can suppress deterioration in picture quality due to coding rate conversion since it corrects re-quantized orthogonal transform coefficients so that a filter intensity does not change, while the filter intensity changes when such correction is not made.

Further, the coding rate converting apparatus 100 can suppress deterioration in coding efficiency since it does not correct re-quantized orthogonal transform coefficients when a filter intensity does not change even in the case where all the coefficients are transformed to 0 through re-quantization.

Note that the first embodiment is described regarding H. 264/AVC as an underlying technique, but the present invention can prevent deterioration in picture quality because of filter intensity change in deblocking filtering due to rate conversion when applied also in other standards for picture coding and decoding.

In other words, the filter intensity change judging unit 108 may judge whether filter intensities in deblocking filtering before and after rate conversion is equal to each other, and the coefficient correcting unit 109 may correct the second quantized data so that a filter intensity does not change, while the filter intensity changes when such correction is not made.

In H. 264/AVC, a filter intensity is changed depending on whether a non-zero coefficient is included or not. However, there is a case where a filter intensity is changed depending on whether a predetermined number of non-zero coefficients are included or not. In this case, the filter intensity change judging unit 108 may judge that a filter intensity changes when the number of non-zero coefficients is changed from the predetermined number or above to a certain number below the predetermined number due to rate conversion. Further, the coefficient correcting unit 109 may correct some non-zero coefficients so that the number of non-zero coefficients included in the second quantized data becomes greater than the predetermined number.

In addition, a picture coding and decoding codec which uses blocks having a 4×4 pixel size are taken as an example in the first embodiment, but the present invention is applicable to picture coding and decoding codec which uses blocks having other pixel sizes.

In addition, a picture coding and decoding codec which uses a six block structure of 4:2:0 (luminance, chrominance, chrominance) are taken as an example in the first embodiment, but the present invention is applicable to another picture coding and decoding codec which uses other block structures such as 4:2:2.

Since the coefficient correcting unit 109 may replace, with 1, the highest frequency coefficient in view of coding efficiency and picture quality in FIG. 11. However, replacement schemes are not limited to this, and any other replacement schemes are possible as long as correction is made so that a current block includes a non-zero coefficient. In other words, the coefficient correcting unit 109 may replace, with a non-zero coefficient, at least one of the quantized orthogonal transform coefficients included in the second quantized data. For example, the coefficient correcting unit 109 may replace another component with 1 or another coefficient, or replace two or more coefficients with non-zero coefficients.

In addition, the filer intensity change judging unit 108 makes judgments in a sequence starting with Step S201 and ending with Step S204 in FIG. 9 in the first embodiment, but any other sequential combinations of S201, S202, S203 and S204 are possible. For example, some or all of Steps 201 to S204 may be executed simultaneously.

### Second Embodiment

In a second embodiment, a description is given of a broadcast stream reception recording apparatus equipped with a coding rate converting apparatus 100 shown in the first embodiment.

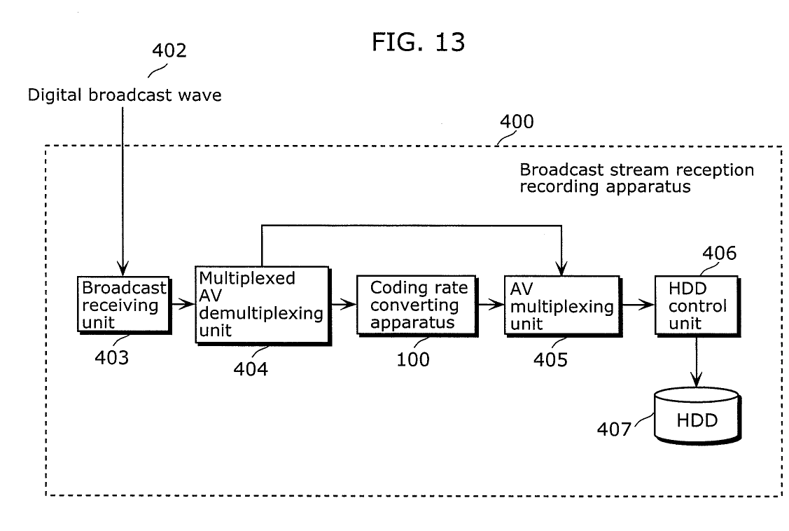

FIG. 13 is a block diagram showing the structure of a broadcast stream reception recording apparatus according to the second embodiment.

The broadcast stream reception recording apparatus 400 shown in FIG. 13 receives a digital broadcast wave 402. The broadcast stream reception recording apparatus 400 converts the coding rate of the digital data included in the digital broadcast wave 402, and stores the digital broadcast wave 402.

The broadcast stream reception recording apparatus 400 includes a coding rate converting apparatus 100, a broadcast receiving unit 403, a multiplexed AV demultiplexing unit 404, an AV multiplexing unit 405, a Hard Disk Drive (HDD) control unit 406, and an HDD 407.

The digital broadcast wave 402 includes several multiplexed programs, is modulated, and is transmitted in a carrier wave. Each of the programs multiplexed in the digital broadcast wave 402 includes data obtained by multiplexing the following: coded video data according to H. 264 AVC, coded audio data according to Advanced Audio Coding (AAC), and system data such as subtitle information or broadcast data.

The broadcast receiving unit 403 generates several programs by demodulating the digital broadcast wave 402. The broadcast receiving unit 403 demultiplexes a single desired program from the several programs, and outputs the demultiplexed program to the multiplexed AV demultiplexing unit 404.

The multiplexed AV demultiplexing unit 404 extracts video data from the program in which video data, audio data and system data are multiplexed, and outputs the extracted video data to the coding rate converting apparatus 100. In addition, the multiplexed AV demultiplexing unit 404 outputs the audio data and system data to the AV multiplexing unit 405.

The coding rate converting apparatus 100 converts the coding rate of the video data to a desired coding rate, and outputs the video data having the converted coding rate to the AV multiplexing unit 405. The coding rate converting apparatus 100 has the same structure as that of the coding rate converting apparatus 100 described in the first embodiment, and thus the description is not repeated here.

The AV multiplexing unit 405 reconstructs a single program by multiplexing the video data having the converted rate and the original audio data and system data outputted by the multiplexed AV demultiplexing unit 404. The AV multiplexing unit 405 outputs the reconstructed program to the HDD control unit 406.

The HDD control unit 406 records the program outputted by the AV multiplexing unit 405 in the HDD 407.

It is assumed here that each program has a coding rate of 24 Mbps in the digital broadcast. In this case, when a 1-hour program is directly recorded in the HDD 407, 10-Gbyte capacity or more is needed. For example, when the HDD 407 has a capacity of 250 Gbyte, only 20-hour data can be recorded in the HDD 407. Hence, there is a need to record a longer-time program in the HDD 407.

In general, the ratio of video data in a program in digital broadcast is approximately nine to ten. The broadcast stream reception recording apparatus 400 according to a second embodiment of the present invention can double the recordable time by, for example, converting the coding rate of the video data to a half.

While it is described in the second embodiment that a digital broadcast wave 402 is inputted to the broadcast stream reception recording apparatus 400, it should be noted that a stream recorded in another HDD without being through coding rate conversion or a stream to be distributed via a network may be inputted to the broadcast stream reception recording apparatus 400.

In addition, while it is described in the second embodiment that the broadcast stream reception recording apparatus 400 records data having a converted coding rate in the HDD 407, it should be noted that the broadcast stream reception recording apparatus 400 may record such data in another recording media, for example, an optical disc such as a DVD or a memory card.

### Third Embodiment

In a third embodiment of the present invention, a description is given of a network distribution system including the coding rate converting apparatus 100 shown in the first embodiment.

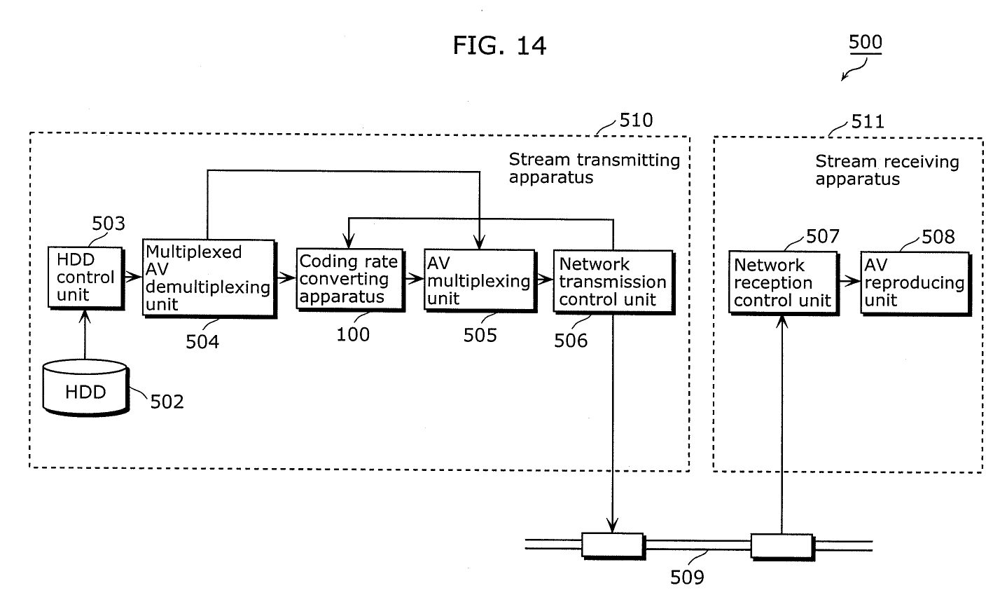

FIG. 14 is a block diagram showing the structure of a network distribution system according to the third embodiment of the present invention.

A network distribution system 500 in FIG. 14 includes a stream transmitting apparatus 510, a stream receiving apparatus 511, and a network 509.

In the network distribution system 500, an AV stream is transmitted from the stream transmitting apparatus 510 to the stream receiving apparatus 511 via the network 509.

The stream transmitting apparatus 510 includes a coding rate converting apparatus 100, an HDD 502, an HDD control unit 503, a multiplexed AV demultiplexing unit 504, an AV multiplexing unit 505, and a network transmitting control unit 506.

The stream transmitting apparatus 510 distributes the AV stream recorded in the HDD 502 to the stream receiving apparatus 511 via the network 509.

The HDD 502 stores programs in each of which a video stream, an audio stream, and a system stream are multiplexed.

The HDD control unit 503 reads the programs from the HDD 502, and outputs the read programs to the multiplexed AV demultiplexing unit 504.

Like the multiplexed AV demultiplexing unit 404 according to the second embodiment, the multiplexed AV demultiplexing unit 504 demultiplexes the video data included in the programs outputted by the HDD control unit 503, and outputs the demultiplexed video data to the coding rate converting apparatus 100. In addition, the multiplexed AV demultiplexing unit 504 outputs the data other than the video data to the AV multiplexing unit 505.

The coding rate converting apparatus 100 converts the coding rate of the video data to a desired coding rate, and outputs the video data having the converted coding rate to the AV multiplexing unit 505. The coding rate converting apparatus 100 has the same structure as that of the coding rate converting apparatus 100 described in the first embodiment, and thus a description for the apparatus is omitted.

The AV multiplexing unit 505 generates an AV stream by re-multiplexing the video data having the coding rate converted by the coding rate converting apparatus, the original audio data and the system data which are to be outputted by the multiplexed AV demultiplexing unit 504. The AV multiplexing unit 505 outputs the re-multiplexed AV data stream to the network transmitting control unit 506.

The network transmitting control unit 506 transmits the re-multiplexed AV stream to the stream receiving apparatus 511 via the network 509. In addition, the network transmitting control unit 506 detects a coding rate for transmitting the re-multiplexed AV stream via the network 509. The network transmitting control unit 506 outputs the detected coding rate to the coding rate converting apparatus 100.

The stream receiving apparatus 511 reproduces the AV stream transmitted by the stream transmitting apparatus 510. The stream receiving apparatus 511 includes a network receiving control unit 507, and an AV reproducing unit 508.

The network receiving control unit 507 receives the AV stream from the network 509, and outputs the received AV stream to the AV reproducing unit 508.

The AV reproducing unit 508 reproduces video (including data broadcast or subtitles) and audio by demultiplexing multiplexed AV and decoding the AV stream. Note that the functions of the AV reproducing unit 508 are not directly related to coding rate conversion, and thus detailed descriptions for these functions are omitted.

Here is a first example case where each program has a coding rate of 24 Mbps in the digital broadcast, and data other than AV streams are simultaneously transmitted in the network 509. In this example case, a 24-Mbps bandwidth cannot be secured for the program frequently. In a second example case where the network 509 is a wireless network, a 24-Mbps bandwidth cannot also be secured for the program frequently because an available bandwidth is changing depending on radio wave conditions. If a necessary bandwidth cannot be secured, data in an AV stream is lost. Such partial losses of data cause errors frequently in the decoding of the AV stream, and thus the lost portions of the AV stream cannot be reproduced.

In the stream transmitting apparatus 510, the network transmitting control unit 506 detects the status of the network 509, and outputs the bandwidth available in the network 509 to the coding rate converting apparatus 100. This enables the coding rate converting apparatus 100 to convert the coding rate of the AV stream to the coding rate available in the network 509. This prevents such losses of the data on the network 509, and therefore the stream receiving apparatus 511 can reproduce the AV stream normally.

It has been described in the third embodiment that the stream transmitting apparatus 510 converts the rate of data stored in the HDD 502 and transmits the data, but it should be noted that the stream transmitting apparatus 510 may convert the rate of digital broadcast or stored data and transmit the data.

In addition, it has been described in the first to third embodiments that the respective blocks which structure the coding rate converting apparatus 100 are typically implemented as a program which functions in an information apparatus including a CPU and a memory, but it should be noted that some or all of these functions may be implemented as a large scale integrated (LSI) circuit. Each LSI may be implemented on a single chip or some or all of these LSIs may be implemented on several chips. The integrated circuit here is called as LSI, but it may be called as an IC, a system LSI, a super LSI or an ultra LSI depending on the integration degree.

An integrated circuit is not necessarily implemented in a form of an LSI, it may be implemented in a form of an exclusive circuit or a general purpose processor. It is also possible to use the Field Programmable Gate Array (FPGA) that enables programming or a reconfigurable processor that can reconfigure the connection or settings of a circuit cell inside the LSI after generating an LSI.

Further, in the case where technique of implementing an integrated circuit that supersedes the LSI is invented along with the development in semiconductor technique or another derivative technique, as a matter of course, integration of the function blocks may be implemented using the invented technique. Bio technique is likely to be adapted.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The present invention is applicable to coding rate converting apparatuses. In addition, the present invention is applicable to, for example, televisions, DVD recorders, personal computers, network distribution systems, stream reception recording apparatuses which include a picture decoding apparatus.

What is claimed is:

1. A coding rate converting apparatus which re-quantizes first quantized data, which has been quantized using a first quantization step size, using a second quantization step size larger than the first quantization step size, said coding rate converting apparatus comprising:
an inverse quantization unit operable to generate orthogonal transform coefficients by inversely quantizing the first quantized data for each of unit blocks;
a quantization unit operable to generate second quantized data by quantizing the orthogonal transform coefficients using the second quantization step size;
a filter intensity change judging unit operable to judge whether or not a second filter intensity determined based on the second quantized data is changed from a first filter intensity determined based on the first quantized data; and
a coefficient correcting unit operable, in the case of the second filter intensity changed from the first filter intensity, to generate third quantized data by correcting the second quantized data so that a third filter intensity determined based on the third quantized data becomes equal to the first filter intensity.

2. The coding rate converting apparatus according to claim 1,
wherein said filter intensity change judging unit is operable to judge that the second filter intensity is changed from the first filter intensity in the case where the number of non-zero coefficients included in the first quantized data is greater than the first predetermined number of non-zero coefficients and where the number of non-zero coefficients included in the second quantized data is smaller than the first predetermined number of non-zero coefficients, and
said coefficient correcting unit is operable to correct the number of non-zero coefficients included in the second quantized data to the number of non-zero coefficients greater than the first predetermined number of non-zero coefficients so as to generate the third quantized data.

3. The coding rate converting apparatus according to claim 1,
wherein said filter intensity change judging unit further includes:
a first judging unit operable to judge whether or not the first quantized data of a current unit block includes a non-zero coefficient;
a second judging unit operable to judge whether or not the second quantized data of the current unit block includes a non-zero coefficient;
a third judging unit operable to judge whether or not the first quantized data of an adjacent unit block adjacent to the current unit block includes a non-zero coefficient; and
a fourth judging unit operable to judge whether or not the third quantized data of the adjacent unit block includes a non-zero coefficient, and
wherein said filter intensity change judging unit is operable to judge that the second filter intensity is changed from the first filter intensity in the case where at least one of the first and third judging units judges that a non-zero coefficient is included and where the second and fourth judging units judge that a non-zero coefficient is not included.

4. The coding rate converting apparatus according to claim 3,
wherein said coefficient correcting unit is operable to generate the third quantized data by replacing, with a non-zero coefficient, at least one of quantized orthogonal transform coefficients included in the second quantized data.

5. The coding rate converting apparatus according to claim 4,
wherein said coefficient correcting unit is operable to replace, with a non-zero coefficient, a highest frequency coefficient from among quantized orthogonal transform coefficients included in the second quantized data.

6. The coding rate converting apparatus according to claim 5,
wherein said coefficient correcting unit is operable to replace, with 1, the highest frequency coefficient.

7. The coding rate converting apparatus according to claim 2,
wherein said filter intensity change judging unit further includes
a fifth judging unit operable to judge whether or not at least one of a current unit block and an adjacent unit block adjacent to the current unit block belongs to a macroblock on which intra-prediction is performed, and
said filter intensity change judging unit is operable to judge that the second filter intensity is not changed from the first filter intensity in the case where said fifth judging unit judges that at least one of the current unit block and the adjacent unit block belongs to the macroblock on which the intra-prediction is performed.

8. The coding rate converting apparatus according to claim 2,
wherein said filter intensity change judging unit further includes
a sixth judging unit operable to judge whether or not filtering is executed on the current unit block, and
said filter intensity change judging unit is operable to judge that the second filter intensity is not changed from the first filter intensity in the case where said fifth judging unit judges that filtering is not executed on the current unit block.

9. A coding rate converting apparatus which re-quantizes first quantized data, which has been quantized using a first quantization step size, using a second quantization step size larger than the first quantization step size, said coding rate converting apparatus comprising:
an inverse quantization unit operable to generate orthogonal transform coefficients by inversely quantizing the first quantized data for each of unit blocks;
a quantization unit operable to generate second quantized data by quantizing the orthogonal transform coefficients using the second quantization step size;
a coefficient correcting unit operable to generate third quantized data by replacing, with a non-zero coefficient, each of at least one of quantized orthogonal transform coefficients included in the second quantized data;
a first judging unit operable to judge whether or not the first quantized data of a current unit block includes a non-zero coefficient;
a second judging unit operable to judge whether or not the second quantized data of the current unit block includes a non-zero coefficient;
a third judging unit operable to judge whether or not the first quantized data of an adjacent unit block adjacent to the current unit block includes a non-zero coefficient; and
a fourth judging unit operable to judge whether or not the third quantized data of the adjacent unit block includes a non-zero coefficient,
wherein said coefficient correcting unit is operable to generate third quantized data by replacing, with a non-zero coefficient, each of the at least one of the quantized orthogonal transform coefficients included in the second quantized data in the case where at least one of the first and third judging units judges that a non-zero coefficient is included and where the second and fourth judging units judge that a non-zero coefficient is not included.

10. An integrated circuit which re-quantizes first quantized data, which has been quantized using a first quantization step size, using a second quantization step size larger than the first quantization step size, said coding rate converting apparatus comprising:
an inverse quantization unit operable to generate orthogonal transform coefficients by inversely quantizing the first quantized data for each of unit blocks;
a quantization unit operable to generate second quantized data by quantizing the orthogonal transform coefficients using the second quantization step size;
a filter intensity change judging unit operable to judge whether or not a second filter intensity determined based on the second quantized data is changed from a first filter intensity determined based on the first quantized data; and
a coefficient correcting unit operable, in the case of the second filter intensity changed from the first filter intensity, to generate third quantized data by correcting the second quantized data so that a third filter intensity determined based on the third quantized data becomes equal to the first filter intensity.

11. A coding rate converting method for re-quantizing first quantized data, which has been quantized using a first quantization step size, using a second quantization step size larger than the first quantization step size, said coding rate converting method comprising:
generating orthogonal transform coefficients by inversely quantizing the first quantized data for each of unit blocks;
generating second quantized data by quantizing the orthogonal transform coefficients using the second quantization step size;
judging whether or not a second filter intensity determined based on the second quantized data is changed from a first filter intensity determined based on the first quantized data; and
generating, in the case of the second filter intensity changed from the first filter intensity, third quantized data by correcting the second quantized data so that a third filter intensity determined based on the third quantized data becomes equal to the first filter intensity.

12. A computer program product which, when loaded into a computer, allows the computer to execute a coding rate converting method, the coding rate converting method which includes:
generating orthogonal transform coefficients by inversely quantizing the first quantized data for each of unit blocks;
generating second quantized data by quantizing the orthogonal transform coefficients using the second quantization step size;
judging whether or not a second filter intensity determined based on the second quantized data is changed from a first filter intensity determined based on the first quantized data; and
generating, in the case of the second filter intensity changed from the first filter intensity, third quantized data by correcting the second quantized data so that a third filter intensity determined based on the third quantized data becomes equal to the first filter intensity.
